(19) United States
(12) Patent Application Publication
(10) Pub. No.: US 2023/0350723 A1
(43) Pub. Date: Nov. 2, 2023

(54) COMPUTER SYSTEM AND PLACEMENT PLAN PROPOSAL METHOD

(71) Applicant: Hitachi, Ltd., Tokyo (JP)

(72) Inventors: Ken NOMURA, Tokyo (JP); Akio Shimada, Tokyo (JP); Mitsuo Hayasaka, Tokyo (JP)

(73) Assignee: Hitachi, Ltd., Tokyo (JP)

(21) Appl. No.: 18/179,536

(22) Filed: Mar. 7, 2023

(30) Foreign Application Priority Data
Apr. 28, 2022 (JP) 2022-075510

(51) Int. Cl. G06F 9/50

(52) U.S. Cl. CPC G06F 9/5038

(57) ABSTRACT

A control server checks whether a resource necessary for process execution is present in a computer system. The control server determines that generating a placement plan is possible when relative guarantee is possible, the relative guarantee guaranteeing a guarantee volume that is at least an absolute resource volume and, if possible, guaranteeing a resource volume reaching an upper limit volume, for a reservation acceptance limit, and starts generating the placement plan. In a period between right after the start of generation of the placement plan and right before permission to selection/approval of the proposed placement plan, the control server makes a reservation with relative guarantee that for the resource and the reservation acceptance limit, makes the guarantee volume and the upper limit volume for the resource volume of the resource different respectively from the guarantee volume and the upper limit volume for the reservation acceptance limit.

### BACKGROUND OF THE INVENTION

### 1. Field of the Invention

The present invention relates to a proposal of resource placement necessary for processing data distributed and placed in a wide area, a computer system that executes resource placement, and a placement plan proposal method.

### 2. Description of the Related Art

Data utilization in a multi-site or multi-cloud environment has started. In this environment, computer resources owned by businesses called on-premises and computer resources globally developed by global businesses called public cloud are utilized. For example, by a method called cloud bursting, a high data load temporarily generated in an on-premises environment is processed by using public cloud computer resources that can be purchased on demand on in a meter-rate charge system. The method is one of attempts to reduce the number of computers, which are needed as physical resources, or total cost.

Data processing in such environments is executed on virtual hardware called virtual machine or on a virtual operation system called container, and their disc image files and container image files are transferred between bases or servers as data transfer between bases or servers. As such technologies become widespread, a proposal of an execution environment that meets users’ demand has become important because users want to know where they can process their data, which are distributed and placed in a wide area, at lower cost or where they can process the data in a shorter time. Hereinafter, main differences between data placement in a wide area and data placement in a base will be described.

First, in the case of data placement in a wide area, is necessary to assume use of resources a public cloud service and the like provides. In particular, when resources of a public cloud is used on demand in a meter-rate charge system, it produces a new cost to pay. It is therefore necessary to assume a case where a user has to wait for getting an approval of a budget as a placement plan is presented and consequently resources are temporarily held unusable for a long time. It is also necessary to assume that in the above case of making a reservation for resources on the public cloud, making a reservation for physical resources is almost equivalent to making a reservation for the budget needed.

Secondly, because a trade-off between cost and performance (processing time) arises, a single optimum placement plan cannot be determined, in which case presenting a plurality of plans to one user needs to be assumed. In addition, because target users are dispersed in a wide area, numbers of users to deal with needs to be assumed.

Thirdly, knowing the volume of remaining resources in a placement destination is essential to creation of an executable placement plan, but respective volumes of remaining resources in numbers of bases distributed in a wide area cannot be acquired in a real time manner as can be acquired in a single base. For example, when data is transferred and processed between bases, a delay in actual use of a resource secured for processing the data arises, the delay corresponding to the size of the data to transfer and to an available network bandwidth. Unless such a delay is taken into consideration, therefore, the volume of remaining resources in each base cannot be known, in which case, for example, it is impossible to properly select free resources of each base and generate numbers of placement plans.

According to a conventional technique, placement plans for virtual machines in an on-premises base is generated, and only the placement proposal verified as a proposal that meets a user’s demand is presented to a system administrator, as a preferable placement proposal. This technique can be applied to container placement as well, but does not present a placement plan for placing containers among bases distributed in a wide area (see JP 2010-146420 A).

### SUMMARY OF THE INVENTION

When trying to collect data distributed among multiple sites in a wide area and analyze the data, a system needs a placement plan indicating data transfer destinations and process execution places (container placement destinations, etc.) between bases. To ensure that the data analysis can be executed according to the placement plan, the system needs to reserve necessary resources before presenting the placement plan to the user. In a wide area, however, executing such an analysis takes much time because of the necessity of budget approval or waiting for data transfer, which poses a problem that the reserved resources are not used effectively until the budget approval or data transfer is completed. In addition, when a single optimum placement plan is not determined and multiple placement plans need to be presented, a resource is reserved independently for each placement plan presented. This case leads to a problem that a resource reservation acceptance margin is too small to accept all reservations and presentation of the placement plan becomes impossible.

The present invention has been conceived to solve the above problems. An object of the present invention is to provide a computer system and a placement plan proposal method that can present more placement plans to more users, using resources effectively.

A computer system according to the present invention includes a plurality of computers connected through a network, and a specific computer. The specific computer generates and proposes a placement plan that determines a place of execution of a process a user wants to execute in the computer system, the process being inputted to the specific computer, and placement of data necessary for the process. The specific computer determines whether a resource necessary for executing the process is present in the computer system. The specific computer determines that generating the placement plan is possible when relative guarantee is possible in the computer system, the relative guarantee guaranteeing a guarantee volume that is at least an absolute resource volume and, if possible, guaranteeing a resource volume reaching an upper limit volume larger than the guarantee volume, for a reservation acceptance margin equivalent to a resource volume serving as criteria for determining whether a reservation for a resource necessary for executing the process is acceptable, and starts generating the placement plan that determines a place of execution of the process and placement of data necessary for the process. In a period between right after start of generation of the placement plan and right before permission to selection and approval of the placement plan, the specific computer makes a reservation with the relative guarantee that for the resource and the reservation acceptance margin, makes the guarantee volume and the upper limit volume for a volume of the resource different respectively from the guarantee volume and the upper limit volume for the reservation acceptance margin.

A computer system according to the present invention includes a plurality of computers distributed and placed in a wide area and connected through a network, and a specific computer. The specific computer generates and proposes a placement plan that determines a place of execution of a process a user wants to execute in the computer system, the process being inputted to the specific computer, and placement of data necessary for the process. The specific computer collects and updates resource information at given timing, the resource information being information on a resource volume of the computers placed in remote places. To determine whether a resource necessary for execution of the process the user wants to execute is present, the specific computer calculates an available resource volume, based on collected resource information, on-propose resource information, and a remaining processing time. Based on the available resource volume, the specific computer generates one or a plurality of the placement plans that determine a place of execution of the process and placement of data necessary for the process, and proposes one or the plurality of the placement plans generated. When one or the plurality of placement plans are selected and approved by the user and a placement plan not selected by the user is present, the specific computer releases the on-proposal resource information on the placement plan not selected by the user, from a subject of calculation of the available resource volume. After data transfer according to the selected and approved placement plan necessary for execution of the process and container transfer for executing the process are carried out, the specific computer releases the on-proposal resource information on the selected and approved placement plan from a subject of calculation of the available resource volume at timing of next updating of the resource information.

A placement plan proposal method according to the present invention is executed in a computer system including a plurality of computers connected through a network and a specific computer, to cause the specific computer to generate and propose a placement plan that determines a place of execution of a process a user wants to execute in the computer system, the process being inputted to the specific computer, and placement of data necessary for the process. The placement plan proposal method causes the specific compute to: determine whether a resource necessary for executing the process is present in the computer system; determine that generating the placement plan is possible when relative guarantee is possible in the computer system, the relative guarantee guaranteeing a guarantee volume that is at least an absolute resource volume and, if possible, guaranteeing a resource volume reaching an upper limit volume larger than the guarantee volume, for a reservation acceptance margin equivalent to a resource volume serving as criteria for determining whether a reservation for a resource necessary for executing the process is acceptable, and start generating the placement plan that determines a place of execution of the process and placement of data necessary for the process; and in a period between right after start of generation of the placement plan and right after permission to selection and approval of the proposed placement plan, make a reservation with the relative guarantee that for the resource and the reservation acceptance margin, makes the guarantee volume and the upper limit volume for a volume of the resource different respectively from the guarantee volume and the upper limit volume for the reservation acceptance margin.

According to the present invention, reservation of a resource necessary for execution of the placement plan and effective use of the resource can be both achieved. Specifically, according to the present invention, such resources as free resources distributed and placed in a wide area, physical resources in temporary reservation that are not used yet, and a reservation acceptance margin are used effectively to allow presentation of more placement plans to more users.

### BRIEF DESCRIPTION OF THE DRAWINGS

FIG. 1 depicts an example of an overall configuration of a system according to an embodiment of the present invention;

FIG. 2 is a hardware configuration diagram of a computer included in the system according to the embodiment of the present invention;

FIG. 3 depicts an example of a configuration of programs and tables stored in a memory of a server included in the system according to the embodiment of the present invention;

FIG. 4 is an example of a sequence diagram showing a basic overall operation of the system according to the embodiment of the present invention;

FIG. 5 depicts an example of a screen displayed on a display connected to a terminal included in the system according to the embodiment of the present invention;

FIG. 6 is a configuration diagram of a resource information table included in the system according to the embodiment of the present invention and ancillary information of the resource information table;

FIG. 7 is a configuration diagram of a placement plan table included in the system according to the embodiment of the present invention;

FIG. 8 is a flowchart showing an operation of a placement plan proposal program included in the system according to the embodiment of the present invention;

FIG. 9 is a flowchart showing an operation of an on-proposal resource management program included in the system according to the embodiment of the present invention;

FIG. 10 is a flowchart showing an operation of a QoS control program included in the system according to an embodiment of the present invention;

FIG. 11 is a flowchart showing an operation of an example of a subroutine of the QoS control program included in the system according to the embodiment of the present invention;

FIG. 12 is a flowchart showing an operation of a data/container control program included in the system according to the embodiment of the present invention; and

FIG. 13 is a flowchart showing an operation of a resource information management program included in the system according to the embodiment of the present invention.

### DESCRIPTION OF THE PREFERRED EMBODIMENTS

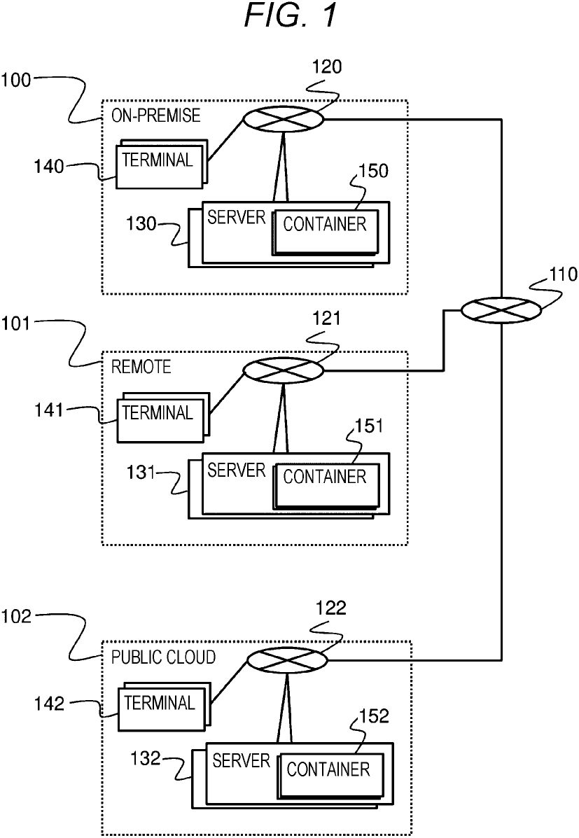

FIG. 1 depicts an example of an overall configuration of a system according to an embodiment of the present invention. The system includes a plurality of bases distributed and placed in a wide area, such as an on-premises 100, a remote on-premises 101, and a public cloud 102, and a wide area network 110 connecting these bases. In the bases, each having a plurality of servers and terminals, servers 130, 131, and 132 and terminals 140, 141, and 142 are connected via local area networks 120, 121, and 122, respectively. On the servers, containers 150, 151, and 152 can be executed, respectively, such that each server runs a plurality of containers. Each container may be a virtual machine, or, in a case where such a virtualization technology is not employed, an application may be directly executed on the server.

Each of the on-premises 100 and the remote on-premises 101 is basically composed of equipment owned. The public cloud 102 is, on the other hand, basically provided as a service, which is used in general by externally accessing it and paying charges according to a predetermined charge models, such as a meter-rate charge system or a flat-rate charge system. The public cloud 102 offers also a resource charge list and a service charge simulation function.

To implement the present invention, a control server needs to be determined from among the servers distributed and placed in a wide area. The control server provides a service for managing and using hardware resources of the servers. For example, when a user accesses the control server from a certain terminal and inputs details of a process the user wants to execute, the control server proposes a placement plan determining where the process is to be executed. Besides, a meta data management service, which is called a metadata server, a catalog server, or the like, is provided also. Metadata is ancillary information on various components in the system, such as the size and type of data and the basic specifications of hardware. The metadata server and the catalog server can be constructed by using an SQL server, a NoSQL server, etc., included in basic software 305, and can be constructed on hardware different from the control server or on the same hardware as the control server. For example, metadata on data or hardware can be obtained by searching for the metadata using the location of the data or hardware as a search key. Alternatively, the metadata can be specified by the location of the data or hardware and the content of the metadata can be updated.

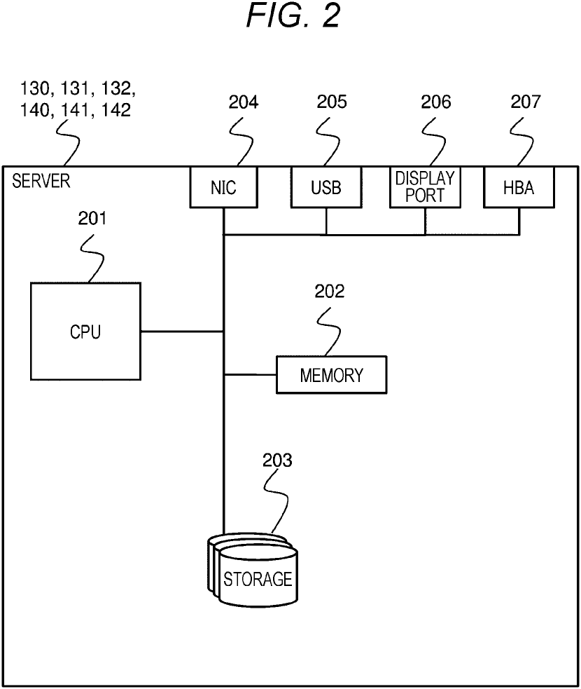

FIG. 2 depicts a hardware configuration diagram of a computer provided as each of the servers 130, 131, and 132 and the terminals 140, 141, and 142 included in the system according to the embodiment of the present invention.

The computer includes a central processing unit (CPU) 201, a memory 202, a storage 203, a network interface card (NIC) 204, a universal serial bus (USB) 205, a display port (DP) 206, and a host bus adapter (HBA) 207. These components are interconnected through an internal bus or an external bus.

A plurality of the CPUs 201, the memories 202, and other components can be incorporated in one computer. Various peripheral devices necessary for operating the computer, such as a keyboard and a mouse, can be connected to the USB 205. The NIC can be connected to the local area networks 120, 121, and 122, the wide area network 110, etc., through wireless communication or wired communication, such as a network cable. To the DP, a display device is connected to display various screens. Various types of storage devices are used as the storage 203, the storage devices including a non-volatile memory express (NVMe) drive, a serial attached SCSI (SAS) drive, a serial ATA (SATA) drive, and a redundant arrays of inexpensive disks (RAID) drive. The storage 203 can be connected to external equipment via the HBA 207. The processing performance of the CPU 201, the capacity of the memory 202, and the band of the NIC 204 are resources with their respective maximum volumes defined. Each resource thus can be used within its maximum volume range. Information about a resource volume, such as the maximum volume and a use volume, is referred to as “resource information”.

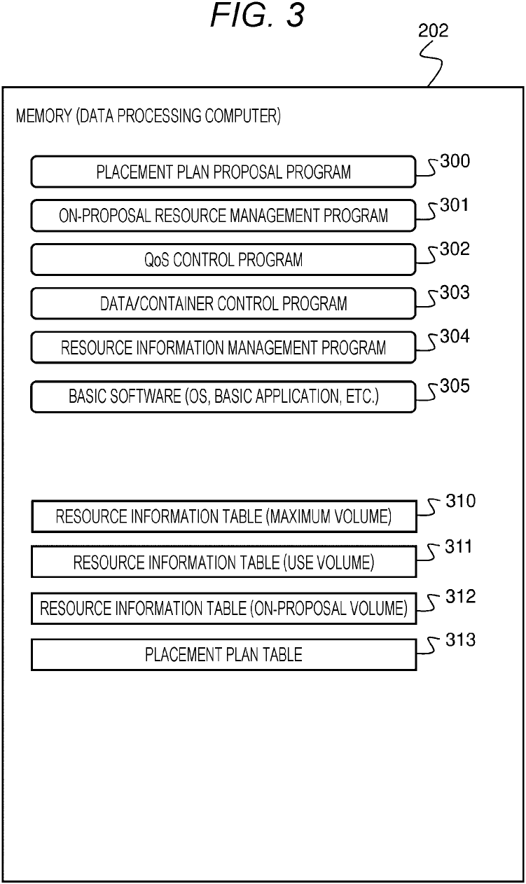

FIG. 3 shows a configuration of main programs and tables arranged on the memory 202 of each of the servers 130, 131, and 132 and the terminals 140, 141, and 142 included in the system according to the embodiment of the present invention. The memory 202 stores a placement plan proposal program 300, an on-proposal resource management program 301, a QoS control program 302, a data/container control program 303, and a resource information management program 304, which are programs newly created for embodiment of the present invention, the basic software 305, which is an operating system (OS), and basic applications equivalent thereto. Specifically, these programs and software are various pieces of existing software including open source software, such as a file system, object storage software, an HTTP server, an FTP server, an SQL server, a non-SQL server, and a flow editor. The memory 202 includes also a plurality of resource information tables 310, 311, and 312, which have the maximum volume of resources of each base, server, or container, the use volume of the same, and an on-proposal volume, i.e., a resource volume being proposed to the user, respectively. The memory 202 further includes a plurality of placement plan tables 313, which have the specific contents of a placement plan being proposed to the user and a placement plan selected by the user. In addition to the above information, the memory 202 further includes other information necessary for execution of the present invention. At each of the servers 130, 131, and 132 and the terminals 140, 141, and 142, therefore, the CPU 201 operates to execute a process assigned to each of the servers 130, 131, and 132 and the terminals 140, 141, and 142, referring to necessary programs and tables. The memory 202 does not store an unnecessary program or table.

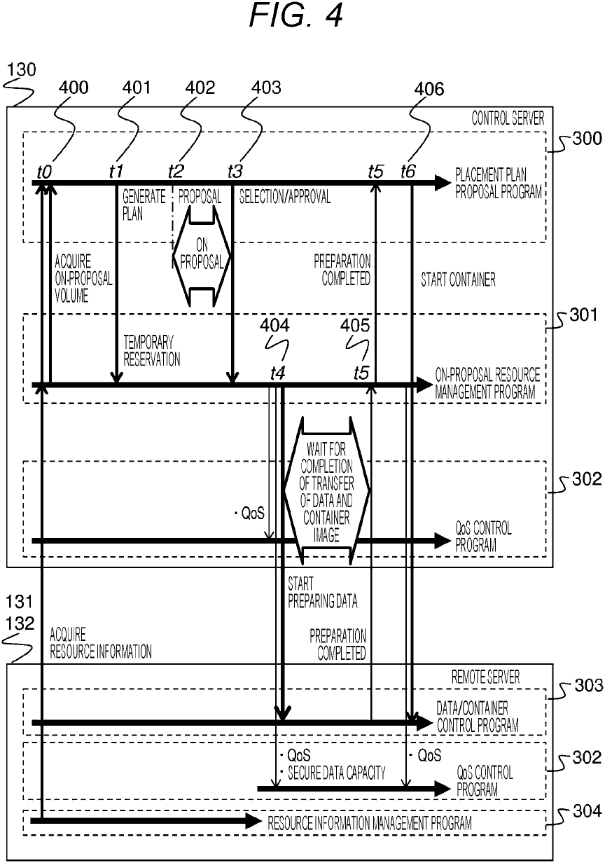

FIG. 4 is an example of a sequence diagram showing a basic overall operation of the system according to the embodiment of the present invention. To implement the present invention, a control server that controls other servers needs to be determined. Now the server 130 is defined as the control server, and the servers 131 and 132 are defined as other servers controlled by the control server. The control server 130 can be operated by making HTTP access thereto from a certain terminal, using a basic application, such as a browser, running on the terminal. In response to a request from the user operating the certain terminal, the control server 130 presents placement plans that determine which container is to be placed in which server. The control server 130 then places and executes the container according to a placement plan selected by the user from the presented placement plans.

At the control server 130, the placement plan proposal program 300, the on-proposal resource management program 301, and the QoS control program 302 run. At the other servers 131 and 132, the QoS control program 302, the data/container control program 303, and the resource information management program 304 run. At every terminal and server, the basic software 305 runs. Hereinafter, an outline of the overall operation will be described in time-sequence order.

At time 400, the control server 130 acquires resource information, such as the maximum volume of resources held by the other servers 131 and 132 and the volume of resources on use, from the resource information management program 304. The acquired resource information and an on-propose resource volume, which will be described later, are held by the on-proposal resource management program 301, and are provided also to the placement plan proposal program 300, which is a main program of the control server 130. Resource volumes are acquired from the other servers 131 and 132 regularly so that no load is applied to the wide area network and the other servers 131 and 132, or are re-acquired irregularly according to a state of data traffic congestion, the number of servers, etc., and are updated to provide the latest resource volume information. A node where resource information can be acquired in real time, such as a server in the same base, may be excluded from the targets of the above regular or irregular information collection. From such a node, resource information may be acquired on demand in a real-time manner when necessary to obtain the latest resource information.

At time 401, a user operating any one of the terminals inputs a workflow indicating a process to be executed and data to be used. The user inputs also related information necessary for deriving a placement plan and reserving a resource, such as a user ID for identifying the user and a desirable processing time. At this time, the user may be able to input all the resource information, such as a CPU volume and a memory volume that are allocated to the process to be executed. However, the user may choose to input only a major requirement, such as the type of the process to be executed, and acquire detailed numerical values, such as a value 602 and a weight 604 for a resource volume necessary for execution of the process, later from the catalog server or the metadata server. An operation of inputting the above workflow can be carried out by, for example, using an open source flow editor included in the basic software 305.

Then, the placement plan proposal program 300 determines the location of an available resource from the workflow and already acquired resource information and generates a placement plan. Generating the placement plan allows finding a free resource and using it effectively. When necessary, the placement plan proposal program 300 generates a single or a plurality of placement plans. For example, when cost and performance have a trade-off relationship and an optimum point is not uniquely determined, a plurality of placement plans need to be created. Various algorithms may be adopted to generate individual placement plans. Nevertheless, the placement plans may be generated by using existing mathematical algorithms. In any case, a free resource corresponding with a necessary resource volume is found. When the found free resource is on the public cloud 122, price information on the resource can be acquired from the public cloud 122 to estimate the cost. At this time, the resource volume necessary for executing the generated placement plan is temporarily reserved, using the on-proposal resource management program 301, and is managed as “on-proposal resource volume”. Temporarily reserving the resource volume ensures that the placement plan is executable.

It should be noted that the above temporary reservation indicates a possibility that reservations for multiple placement plans presented, except a reservation for selected one, may be canceled. The temporary reservation indicates also an initial state in which securing a reservation acceptance margin is essential but securing physical resources not always necessary. In other words, QoS guarantee for physical resources, which can be made at time 404 or time 406, may be made in advance at the time 401 according to the system configuration or necessity or the content of the QoS guarantee may be determined beforehand by outputting a setting file. The reservation acceptance margin is equal to a remaining resource volume given by subtracting “on-use resource volume” and “minimum required reserved resource volume” from the “maximum volume of resources held”. When this remaining resource volume is smaller than a given value, a reservation cannot be accepted because of the need of preventing excessive reservation. By avoiding unnecessary use of this reservation acceptance margin, the saved reservation acceptance margin can be used for presentation of a placement plan to another new user.

At time 402, the executable placement plan generated by the placement plan proposal program 300 is proposed to the user. The user approves the placement plan presented or is allowed to select a maximum examination time used for examining the plan or a quality of service (QoS) level at execution of a process.

At time 403, the user approves a single placement plan presented or selects and approves one of a plurality of placement plans. The user may select no placement plan at all, in which case the user cancels a request to end the session.

At time 404, the on-proposal resource management program 301 properly makes necessary QoS guarantee and secures a necessary resource, using the QoS control program 302, according to the approved placement plan and the user’s request. For example, when the control server 130 provides data or a container image, to secure a necessary network band, the QoS control programs 302 of both the control server 130, which is a transmission origin, and the server 131 or server 132, which is a transmission destination, are used. Then, transfer of the data and container image to a place where the process is executed starts. This data transfer may be carried out in the form of data copying, in which case the data remains in both transmission origin and transmission destination.

At time 405, transfer of the data and container image is completed. A completion notice is transmitted to the placement plan proposal program 300 and to the on-proposal resource management program 301. At this time, the on-proposal resource management program 301 changes the state of the on-proposal resource to a preparation state (change from the temporary reservation state to the preparation state). In the preparation state in which data and a container image are transferred, a fact that the band of the wide area network is actually consumed needs to be taken into consideration in calculation of an available resource volume.

At time 406, the container is started using the container image, which starts the process specified by the user. In addition, resources necessary for the process are secured, using the QoS control program 302. The start of the container is imparted to the on-proposal resource management program 301, which changes the state of the on-proposal resource to a started state (change from the preparation state to the started state). In the started state, resources necessary for executing the process are actually consumed. At a point of time of transmission of the latest resource information from the resource information management program 304, the transmission being carried out regularly or irregularly from time 400, the resource volume of the on-proposal resource in the started state becomes null and is released.

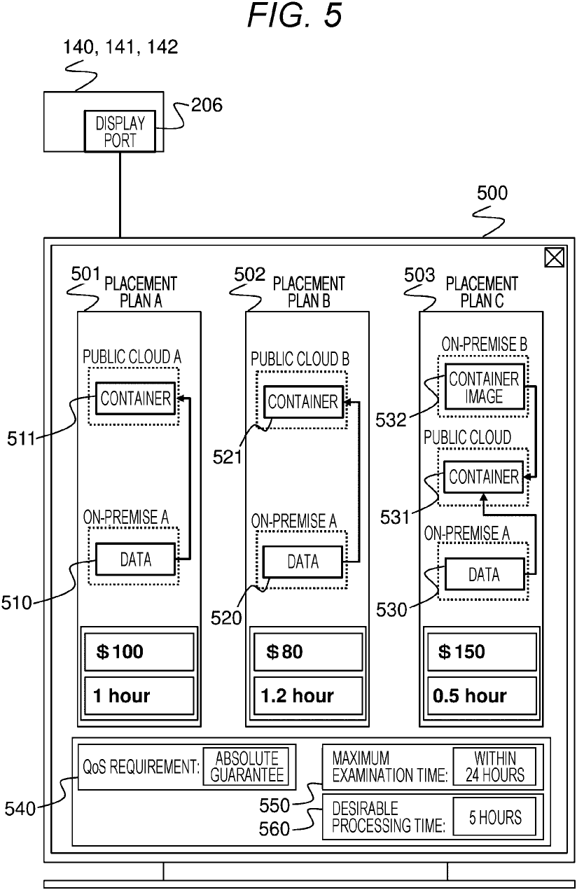

FIG. 5 depicts an example of a screen put on a display connected to the terminal included in the system according to the embodiment of the present invention. A display 500 is connected to the DP 206 of each of the terminals 140, 141, and 142. At the above time 402, the display 500 displays a placement plan A 501, a placement plan B 502, a placement plan C 503, a QoS request input interface 540 for inputting a user request, a maximum examination time input interface 550, and a desirable processing time input interface 560.

The placement plan A 501 proposes a plan to transfer data 510 to a public cloud A and process the data 510 using a container 511, and indicates a standard cost and a standard processing time that the process takes. The placement plan B 502 proposes a plan to transfer data 520 to a public cloud B and process the data 520 using a container 521. The placement plan C proposes a plan to transfer data 530 and a container image 532 respectively from different bases to the same public cloud and process the data 530.

To ensure that these placement plans are executable, resources necessary for the placement need to be reserved in advance, which requires that a resource commonly used between the placement plans be reserved in such a way as to be not reserved redundantly. Redundant reservation of such a resource creates a problem that despite a fact that resources necessary for executing individual placement plans are available, a plurality of placement plans cannot be presented because of a shortage of resources and a problem that a resource supposed to be available for presentation of a placement plan to another user is wasted.

The user is allowed to click one of these placement plans and approve execution of the clicked placement plan or to close the placement plan presentation screen without selecting no plan, that is, cancel the placement without giving any approval. Before selecting a placement plan, the user is able to select a QoS guarantee level at execution of the placement plan, using the QoS request input interface 540. For example, the user is able to select a service level at which securing necessary resources is absolutely guaranteed or a service level at which full resource allocation is not required and first priority is given to execution of the placement plan with resources that can be allocated proportionally by relative guarantee or a service level at which securing resources depends completely on best-effort allocation. The user is also able to display an alternative that first making a reservation at the relative guarantee level because of a shortage of resources and then switching to the absolute guarantee level when a free resource becomes available before execution of the container, and an alternative that waiting until a free resource becomes available and then switching to the absolute guarantee level.

In addition, the user is also able to select a longest examination time that can be spent for examination of a placement plan, using the maximum examination time input interface 550. For example, taking account of a time required for approval of costs that would arise, the user is also able to extend the time required for cost approval in order in such a manner: 5 minutes or less, 1 hour or less, 1 day or less, 1 week or less. As a result, the control server 130 is able to grasp the length of a temporary resource holding time resulting from a wait for the user’s response, thus being able to set a fair execution priority order corresponding to the length of the maximum examination time. When the maximum examination time has elapsed as the user selects no placement plan, the control server 130 activates a timeout function to forcibly end presentation of the placement plans.

Then, the desirable processing time input interface 560 receives the user’s input of a desirable execution time for the process placed by the placement plan. Because the processing time is a parameter that can be used also to derive the placement plan, the desirable processing time input interface 560 is displayed also at time 401 at which an initial value can be inputted to the desirable processing time input interface 560. In such a case, the desirable processing time input interface 560 plays the role of displaying the initial value or receiving input of a changed desirable processing time. The exact meaning of the execution time differs depending on a process to be executed and a system configuration. Inputting the execution time means, for example, simply inputting a scheduled use period or inputting a delivery period including a preparation time for data transfer or container image transfer. In other cases, e.g., a case of an analytic process whose accuracy improves as the execution time gest longer, it means inputting a net consecutive execution time not including a preparation time for data transfer, etc.

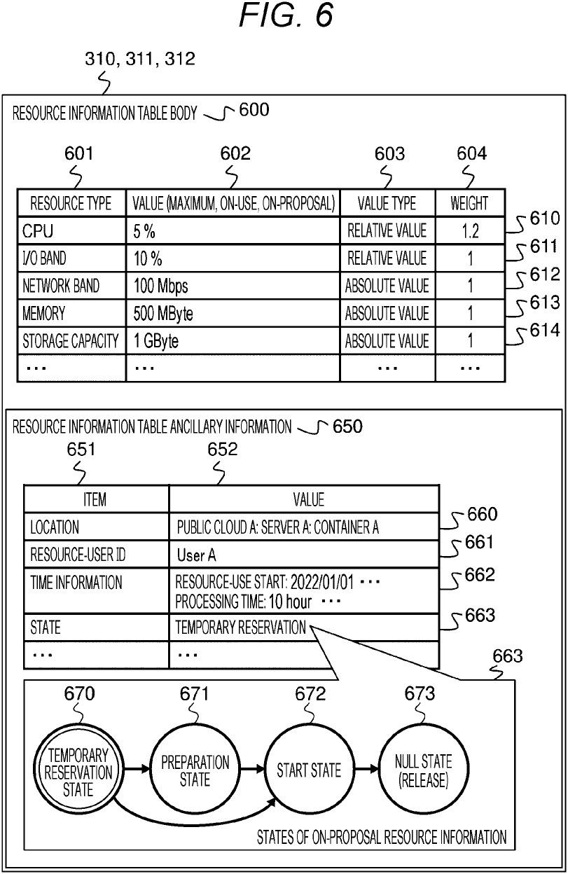

FIG. 6 shows an example of a configuration of each of the resource information tables 310, 311, and 312 included in the system according to the embodiment of the present invention. A resource information table body 600 has four columns of resource type 601, value 602, value type 603, and weight 604. In a row 610 and a row 611, for example, respective use volumes of the CPU and the I/O band are expressed in percentage that is a relative value relative to a maximum value. In a row 612, a row 613, and a row 614, the use volumes of the network band, the memory, and the storage capacity are expressed respectively as absolute values of 100 Mbps, 500 Mbyte, and 1 Gbyte.

The resource information table 310 mainly holds the maximum value of a resource volume each base has, as an absolute value, using a number that is required according to node units, such as base-by-base and server-by-server. Similarly, the resource information table 311 holds the use volume or the on-proposal volume of the resource of each base, as an absolute value or a relative value relative to a maximum value. Whether a value is a relative value or an absolute value can be determined by referring to the value type 603.

The resource information table 312 holds a resource volume consumed by each placement plan being proposed by the control server 130, as an absolute value or a relative value. The resource information table 312 may specify proportional allocation by expressing the resource volume, for example, as a relative value of 10 Mbyte. Specifically, if an available remaining resource volume is sufficient, the whole of 10 Mbytes is allocated. If it is not enough for allocation of 10 Mbytes, however, a resource whose volume is less than 10 Mbytes, a requested volume, is allocated proportionally. For example, if two users each request a resource of 10 in a situation where only a resource of 10 is available, a resource of 5 is allocated to each user according to the proportional allocation rule by which the resource is allocated in proportional to each requested volume. Items making up the resource type 601 column may be different from the above described items. If the local area networks 120, 121, and 122 and the wide area network 110 are different in maximum bandwidth from each other, their bandwidths may be recorded in different rows. Multiple network paths (network ports) may be treated as different items or an essential memory volume and an arbitrarily added memory volume are may be treated as different items. In this manner, these items are categorized as different resource types and are therefore recorded in different rows, according to a system configuration and necessity. Weight 604 specifies the weight of value 602. The weight of value 602 is a coefficient for standardizing a value. For example, by simply multiplying value 602, which indicates a resource volume, such as the number of cores of the CPU, by weight 604, resource volumes can be compared at the same criteria between servers different in hardware performance. The same CPU resource may vary in properties. For example, one CPU core shows differences in processing performance depending not only on the type of hardware but also on the characteristics of an application trying to use the CPU. Such differences, in some cases, affect other resources, such as a memory volume to be consumed, an I/O band, a network band, and a storage capacity for caching. These differences, however, can be corrected by multiplication of weight 604. The value of weight 604 is stored in advance in the metadata server or the catalog server and can be acquired therefrom. It should be noted that comparisons and calculations of resource volumes described in this specification are carried out on the assumption that all values are standardized by being multiplied by weight 604. This is, however, irrelevant to the substance of the present invention and describing it would be extremely troublesome. Details of such calculations are therefore not described herein.

The above table body 600 has ancillary information 650 including two columns of item 651 and value 652. A row 660 indicates the locations of resources. In the row 660, the locations of resources can be specified in any given node units, such as base-by-base (public cloud 102, etc.), server-by-server, and container-by-container. In other words, the table body 600 can show resource volume entries in any given node units selected from base-by-base, server-by-server, and container-by-container units. Rows 661, 662, and 663 indicate ancillary information that is added in a case of mainly handling on-proposal resource volumes. The row 661 holds a user ID for specifying a user who intends to use a resource or a resource owner. The row 662 stores various pieces of time information on a resource. Specifically, the row 662 holds time information on the start or end of use of a resources, such as a time when data transfer is started or completed and a time when the container is started or ended, and holds also other time information, such as a maximum examination time and a desirable processing time inputted by the maximum examination time input interface 550 and the desirable processing time input interface 560. The row 663 indicates a resource state, which is one of these four states: a temporary reservation state 670, a preparation state 671, a started state 672, and a null state 673.

In each of these states, which correspond to a preparation stage in which the container image is transferred between bases, a stage in which the container is started, etc., the volume of a resource actually being consumed or the volume of a resource having been used and not needed any more may possibly change. The resource information tables 310, 311, and 312 for a resource in its null state 673 are deleted.

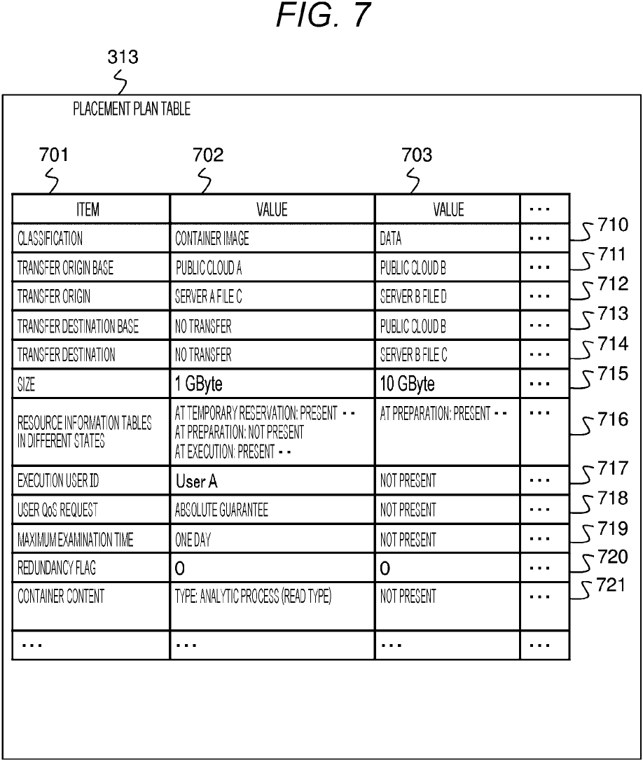

FIG. 7 is a configuration diagram of a placement plan table 313 included in the system according to the embodiment of the present invention. The placement plan table has value columns as many as necessary for defining a placement plan, such as columns of item 701, value 702, and value 703. A row 710 indicates the type of a resource to be placed, such as a container image or data. A row 711 indicates a base in which a resource to be placed is present, such as the public cloud A or the on-premises B. A row 712 indicates the location of a resource to be placed in a base, such as a file C of a server A and a file D of a server B. A row 713 and a row 714 indicate a transfer destination base to which a resource to be placed is transferred and the location of the resource in the transfer destination base, respectively. These rows 713 and 714 can be omitted when the resource is not transferred. A row 715 holds a data size, which allows the user to know a storage capacity needed for data storage and a traffic volume resulting from data transfer. When a placement plan is being executed and data is being transferred, such information as the size of transferred data can also be held in the row 715. Such information, however, may be included, for example, in a storage capacity in the row 614 of the resource information table. A row 716 holds a resource volume that is needed when a container is started using a container image. Specifically, what is held in the row 716 is a reference to the resource information table 312 or the resource information table 312 itself. The row 716 thus holds a plurality of resource information tables 312 for different states, such as a resource information table 312 for the preparation state 671 and a resource information table 312 for the started state 672. If it is predetermined that the network band is used only in the preparation state 671, only one resource information table 312 may be held in the row 716. Value 602 of the resource information table 312 is calculated by an algorithm for generating a placement plan. In another case, value 602 can be acquired from the metadata server or the catalog server in the same manner as information in a row 721, which will be described later, is acquired from the metadata server or the catalog server. A row 717 indicates an ID for identifying a user who executes a container. A row 718 indicates a QoS level the user requires. This QoS level is inputted by the user on the QoS request input interface 540. A row 719 holds a maximum examination time inputted by the user. This maximum examination time is inputted by the user on the maximum examination time input interface 550. Entries in the rows 717, 718, 719, and 720 can be omitted for a resource to be placed that is not executable, such as data. Usually, the same entries are made for the same placement plan. Such entries, therefore, may be saved as ancillary information separated from information in the table body. A row 720 holds a redundancy flag indicating that in multiple placement plans presented, the same resource is present in one placement plan and another placement plan as well. For example, a flag value 1 is set when redundant resource placement is found, while a flag value 0 is set when redundant resource placement is not found. This step will be described in detail later in the description of a flowchart. The row 721 stores information on the content of a container image. Specifically, the row 721 stores metadata on the container image that can be acquired from the metadata server or the catalog server. This allows the user to confirm, for example, the type of an application that is executed when the container is started. The user is thus able to know a major operation of the application, that is, whether the application runs to mainly read data or mainly write data. In addition, from the information in the row 721, the user is also able to acquire information on resource consumption, such as CPU consumption and memory consumption that result when the application is executed.

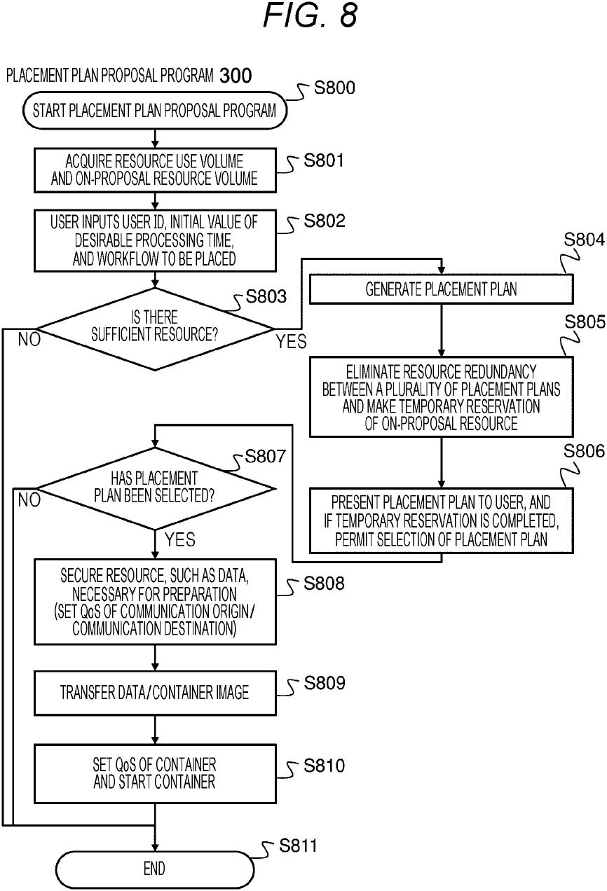

FIG. 8 is a flowchart showing an operation of the placement plan proposal program 300 included in the system according to the embodiment of the present invention. The program is started when the user, who requires presentation of a placement plan, operates any one of the terminals 140, 141, and 142 to access the control server 130 (S800). First, the user acquires a resource use volume and an on-proposed resource volume from the resource information management program 304 and the on-proposal resource management program 301 (S801). Because making inquires to all bases in every resource volume acquisition creates a high processing load, the latest values cached may be acquired. In particular, inquiries to the resource information management program 304 in a different base can be made regularly or irregularly not in synchronization with the program 300. The resource information tables 310 and 311, which are transmitted and received, store the maximum volume and the use volume of resources in proper node units selected from base-by-base, server-by-server, and container-by-container units, according to an actual system configuration and a placement plan generation algorithm. Subsequently, the user inputs a workflow defining a user ID (user identifier), a desirable processing time for a process to be placed, and the content of the process. The user is able to input the workflow by any given method, such as inputting text data, selecting from a list, or specifying a setting file (S802). Such information as the type of the container image corresponding to the process described in the workflow and a resource volume necessary for execution of the process can be acquired from the metadata server or the catalog server. Whether a resource necessary for executing the process in the workflow is available can be determined by comparing the result of “resource maximum volume-on-use volume-on-proposal resource volume”, which can be calculated by referring to the resource information tables 310, 311, and 312, with a resource volume necessary for the process the user wants to execute to see whether the result of the calculation exceeds the resource volume. At this time, for example, an on-proposal resource volume in the resource information table 312, the on-proposal resource volume having a remaining time given by subtracting an already elapsed time from a desirable processing time indicated by time information stored in the row 662 and sufficiently small relative to a data transfer wait time calculated from a given threshold, the size of data that may be transferred, and an available network bandwidth, may be considered to be equivalent to a free resource volume and therefore may be excluded from the on-proposal resource volume in the above calculation formula.

In a case where the latest resource volume can be confirmed in real time, such as a case of confirming a resource volume between servers adjacent to each other in the same base, the latest resource volume may be acquired on demand in a real time manner before carrying out the above calculation. This determination is made for all related resource types indicated in resource type 601 (S803). When the available resource is not present, an error message, etc., is displayed and the process flow is ended. This prevents an excessive reservation volume exceeding a remaining resource volume (S811). When the available resource is present, a placement plan is generated. The placement plan can be generated by using an existing mathematical algorithm or the like.

A plurality of placement plans may also be generated by, for example, using random numbers or calling a mathematical algorithm multiple times under different conditions (S804). The case of generating a plurality of placement plans raises a possibility that the same resource is used redundantly between different placement plans in the placement plan tables 313. To avoid such a case, all placement plans are checked to see whether the same resource is present simultaneously in different placement plans, and when such redundancy is found, one redundancy flag 720 is set. More specifically, a resource with the same user ID in the row 717, the same transfer origin in the rows 711 and 712, and the same transfer destination in the rows 713 and 714 is defined as the same resource, and such a resource being found is a redundancy case. Finding the redundancy case in the above manner prevents an excessive reservation volume resulting from presentation of a plurality of placement plans. When the redundancy check is over, all resources for which no redundancy flag in the row 720 is set are imparted to the on-proposal resource management program 301 to temporarily reserve the resources. The on-proposal resource management program 301 holds the entire resource information 312 on on-proposal resources and knows their states indicated as the temporary reservation state in the row 663 (S805). The placement plans are presented to the user in the form as shown in FIG. 5. If the redundancy check and temporary reservation are completed, the user’s selection of a placement plan is permitted. In other words, a graphic process for presenting the placement plans and a process of the temporary reservation process may be carried out in parallel, and among the placement plans, a placement plan for which a temporary reservation is completed can be selected first in order (S806). Then, after the user’s input or timeout, whether a placement plan is selected is checked (S807). When none of the presented placement plans is selected, the process flow is ended (S811). When one placement plan is selected, the on-proposal resource management program 301 resets all redundancy flags in the row 720 for the selected placement plan and deletes all placement plan tables 313 for other placement plans not selected, thereby disposing of temporary reservations not needed any more. The on-proposal resource management program 301 then sends the selected placement plan to the QoS control program 302, thereby actually making QoS guarantee and securing the resource. Basically, the wide area network band necessary for transferring a container image and data between the bases needs to be secured. However, if resource information tables in different states in the row 716 for the preparation phase are separately specified in the placement plan table 313, the resource information tables are referred to. If the resource information tables are not specified, a process of QoS guarantee and resource securing for a preparation resource that are defined according to the system configuration is carried out (S808). The data and the container image are transferred (S809), and when the transfer is completed, the container is started. At execution of the container, in the same manner as in the preparation phase, if the resource information tables in different states in the row 716 for the execution phase are specified, the resource information tables are referred to. If the resource information tables are not specified, a given process of QoS guarantee and resource securing is carried out (S810). Following execution of the container, the program comes to an end (S811).

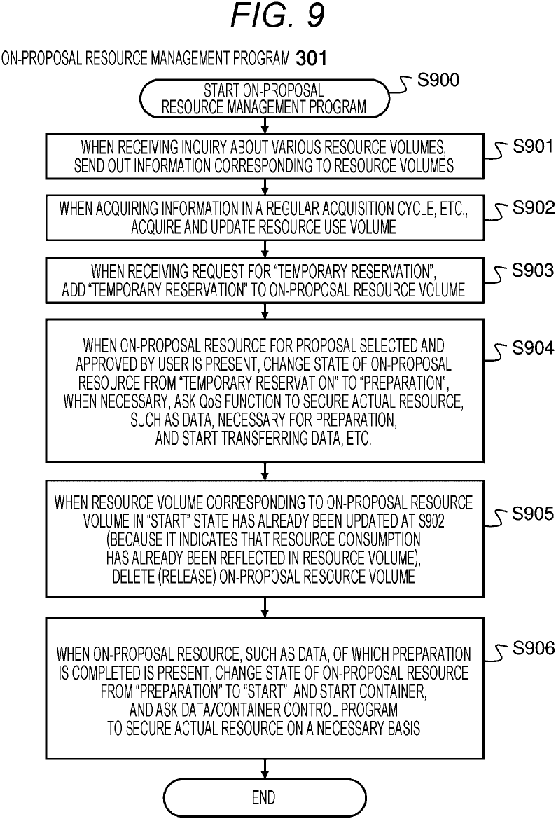

FIG. 9 is a flowchart showing an operation of the on-proposal resource management program 301 included in the system according to the embodiment of the present invention. The on-proposal resource management program 301 operates in cooperation with the QoS control program 302 that manages physical resources, thereby separating a surplus of physical resources from a reservation acceptance margin for the physical resources to allow independent reservation of individual physical resources. For example, in response to one resource request from one user, a resource reservation can be made with relative guarantee of making resource guarantee volumes different, the relative guarantee requiring that a physical resource and the reservation acceptance margin be at least guaranteed. Relative guarantee offers various effects including minor ones. Simply speaking, relative guarantee prevents a case where the reservation acceptance margin is fully consumed unnecessarily despite a fact that the proposal phase, in which a QoS guarantee level the user requires and approval of a placement plan are not ensured yet, is still going on. Relative guarantee, therefore, allows presenting more placement plans to more users.

The program starts when it re-executes itself regularly or irregularly or when called by a different program (S900). The program then carries out a process in response to a request from the different program. First, when the request is an inquiry about various resource volumes, the program provides the corresponding resource information tables 310, 311, and 312 according to inquiry details (S901). Subsequently, when the request is regular or irregular re-execution of the program itself, the program acquires the resource information tables 310 and 311 again and updates their information contents to the latest one. When information is collected from numbers of bases distributed in a wide area, updating all pieces of information at once may be impossible and therefore pieces of information are updated in order in rotation cycles, with updating ranges properly divided. In addition, when information cannot be updated according to a schedule due to a network delay, data traffic congestion, etc., a responsive action corresponding to the system configuration, such as separate irregular updating of information not updated, is taken. These updating processes are continuously carried out when this program 301 re-executes itself (S902). When receiving a resource temporary reservation request from the placement plan proposal program 300, the on-proposal resource management program 301 holds the resource information tables in different states in the row 716, the resource information tables being in the placement plan table 313, as an on-proposal resource volume in the row 312, and sets the state of the on-proposal resource volume indicated in the row 663 to the “temporary reservation state 670”. When the resource information tables in different states in the row 716 specify different resource information tables 312 according to the preparation state, on-execution state, etc., the resource information table body 600 to be referred to is switched according to a state indicated in the row 663 (S903). When receiving a notice of the user’s having selected one of a plurality of placement plans, the program 301 deletes the on-proposal resource information 312 on placement plans in the “temporary reservation state” that are different from the placement plan selected by the user, that is, releases the on-proposal resource information 312. The program 301 then sets a state in the row 663 in the resource information 312 on the selected placement plan, to the “preparation state 671”. When no data or container image to transfer is present and therefore no preparation phase is necessary as the container has been started in advance, the state can be directly changed to the “started state 672”. Subsequently, the program 301 asks the QoS control program 302 to carry out QoS guarantee and resource securing corresponding to the state in the row 663. The program 301 then instructs the data/container control program 303 to transfer the data and the container image (S904). If the on-proposal resource information 312 in the “started state 672” includes the resource information 310 and 311 corresponding to the on-proposal resource information 312 in base or location and updated at step S 902, it indicates that resource consumption resulting from execution of the container has been reflected in the resource information 310 and 311. For this reason, the on-proposal resource information 312 in the “started state 672” is deleted, i.e., released (S905). Finally, when receiving a notice of completion of transfer of the data and container image, that is, completion of the preparation phase, the program 301 changes the “preparation state 671” in the row 663 of the on-proposal resource information 312, to the “started state 672 ” in response to the notice received. Subsequently, the program 301 asks the QoS control program 302 to carry out QoS guarantee and resource securing corresponding to the state in the row 663. Because the updating at step S902 is not activated by this notice of completion of the preparation phase, step S902 is separately executed later and consequently the on-proposal resource information 312 is released at step S905 described above (S906).

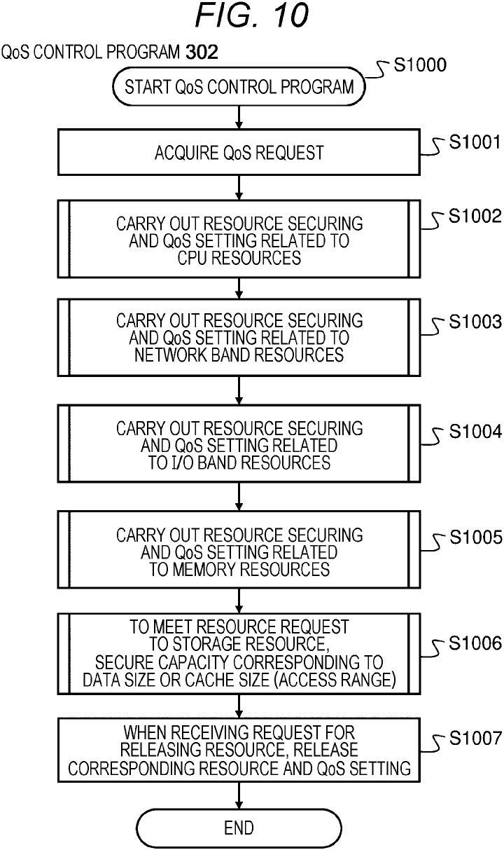

FIG. 10 is a flowchart showing an operation of the QoS control program 302 included in the system according to an embodiment of the present invention. The QoS control program 302 can be run on the remote servers 131 and 132. It, however, may be run on the control server 130, where the QoS control program 302 calls a QoS function included in the basic software 305 of the remote servers 131 and 132. In any case, the final process for QoS guarantee and resource securing is under control by an OS and is therefore implemented by the function of the basic software 305.

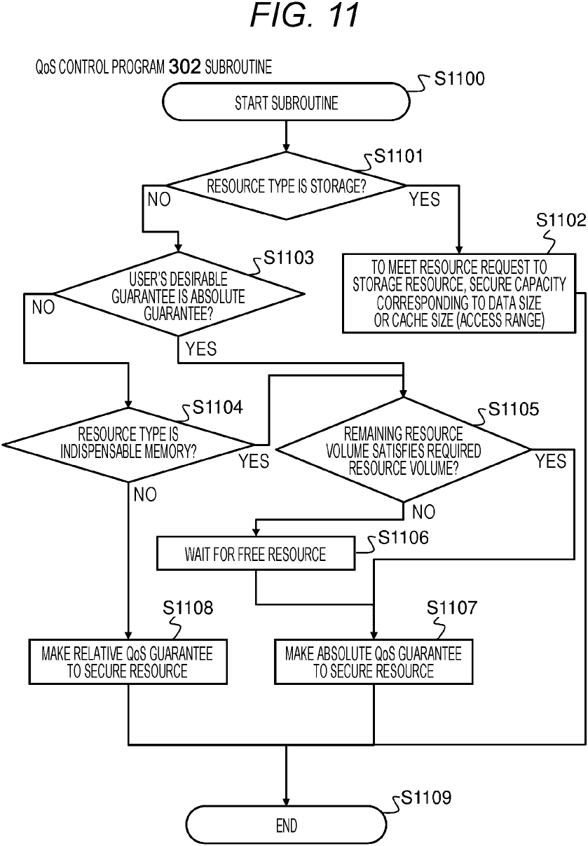

The program 302 starts when called by the on-proposal resource management program 301 (S1000). First, the program 302 receives a QoS request transmitted from the on-proposal resource management program 301 in the form of the resource information table 312 (S1001). When receiving the request, the program 302 executes QoS guarantee and resource securing for each of resources, such as a CPU, a network, an I/O band, a memory, and a storage. Specific process details are described in a subroutine shown in FIG. 11 (S1002, S1003, S1004, S1005, S1006). When receiving a request for releasing QoS guarantee and resource securing having already been carried out, the program 302 cancels setting of the specified QoS guarantee and resource securing. Such a process can be easily carried out by a method of sending back a unique identifier to the on-proposal resource management program 301 at execution of QoS guarantee so that the on-proposal resource management program 301 makes a release request with the identifier attached thereto (S1007).

FIG. 11 depicts an example of a flowchart showing an operation of a subroutine of the QoS control program 302 included in the system according to the embodiment of the present invention. The subroutine of the QoS control program 302 offers a function of properly making QoS setting, such as absolute QoS guarantee and relative QoS guarantee, on a necessary basis. “On a necessary basis” means that the necessity of absolute QoS guarantee or relative QoS guarantee is determined according to an absolute guarantee request from the user, characteristics that vary depending on the types of resources, or the like. Specifically, a resource called storage capacity cannot store data unless it has a full capacity required for data storage, and once the data is written to the storage capacity, it cannot be used for other purposes. This means that in the case of the storage capacity, its resource that is scheduled to be used in near future but is not used at present cannot be lend out. In principle, therefore, the storage capacity must be guaranteed absolutely. Now the memory is similar in characteristics to the storage in terms of resource. The memory is, however, different from the storage in that waiting until a process occupying the memory ends allows use of the memory as a resource. Besides, some types of applications absolutely need a minimum memory capacity but treat an additional memory capacity as a backup resource the more of which the applications get, the more advantages the applications have. Such a memory capacity is not essential one and relatively guaranteeing it poses no problem. Meanwhile, such resources as the CPU, the I/O band, and the network band basically allow execution of a process even if the full resource volume is not obtained. They allow execution of the process using them with their performance degraded through time division, reduced bands, etc. In addition, such a resource not on use can be lent out to a different process and can be returned when it is no longer needed. The subroutine of the QoS control program 302 starts when called at steps S1002, S1003, S1004, S1005, S1006, etc., of the QoS control program 302 (S1100). First, the subroutine checks whether the type of a resource for which QoS guaranteed is to be made is a storage capacity (S1101). When the type of the resource is the storage capacity, the storage capacity is secured by a method of creating a dummy file of a requested data size, a method of creating an area with a limited capacity by a quota function of the basic software 305, or the like. By another method, for example, a cache area that can cover an access range actually arising in data is secured under given conditions, such as the user’s QoS request is at a relative guarantee level or a process specified in the row 721 of the placement plan table 313 is a process focusing on data reading. As a result, the storage capacity that needs to be secured can be reduced. The above access range can be acquired from the QoS control program 302 which calls the subroutine (S1102). When determining at step S1101 that the type of the resource is not the storage, on the other hand, the subroutine checks whether the QoS guarantee the user wants is absolute guarantee (S1103). When the QoS guarantee is not the absolute guarantee, the subroutine then checks whether the type of the resource is an essential memory (S1104). When the type of the resource is not the essential memory, the subroutine secures a physical resource with relative QoS guarantee (S1108). When the user wants the absolute guarantee or the type of the resource is the essential memory, on the other hand, the subroutine compares a requested resource volume with an available resource volume to check whether the requested resource volume can be secured (can be guaranteed absolutely) (S1105). When the requested resource can be secured, the subroutine secures a physical resource with absolute QoS guarantee (S1107). Relatively or absolutely securing the physical resource and making the relative or absolute QoS guarantee can be carried out by the basic software 305. Specifically, methods for relatively or absolutely securing the physical resource and making the relative or absolute QoS guarantee include a method of using a command for placing resource limitations or making QoS setting, such as traffic control (TC) or control groups (cgroups), the command being included in the basic software 305, and a method of writing the QoS guarantee content to a setting file called manifest for describing conditions at the start of the container, using open source software for managing the container, such as Kubernetes. Furthermore, if the physical resource is a resource that can be additionally secured on demand, such as a resource on a public cloud that is purchased by a meter-rate charge system, reserving a budget needed for securing the resource is substantially equivalent to reserving the physical resource. Price information on various resources on the public cloud is disclosed on the Internet, and can be acquired by such a communication means based on a hypertext transfer protocol (HTTP). Using such information, a cost needed for securing a resource volume to be reserved can be calculated. In other words, because a necessary resource volume can be easily translated into a budget needed, reserving the budget allows reserving the resource on the assumption that plenty of purchasable resources are provided on the public cloud. Such information as a flag indicating a reservation being a budget reservation, a reservation status, and a calculated cost can be saved in, for example, the resource information table ancillary information 650. At step S1105 of the subroutine of the QoS control program 302, it is determined whether the reminder of a budget the user can use, the budget being on a database included in the basic software 305 or on an external database, exceeds a total amount of the cost needed for resource reservation. When the relative or absolute QoS guarantee is completed, the subroutine is ended (S1109).

The subroutine 302 described above can be deployed by such an algorithm, and may also be deployed by a method of creating a table with the vertical axis representing resource types and the horizontal axis representing user requests and defining what QoS guarantee and resource reservation are to be made under individual conditions. Tabulating allows minor adjustment and customization of processing details to be carried out easily in accordance with the system configuration. In other words, any given QoS guarantee can be selected under any given conditions without being limited to the QoS guarantee made by the above algorithm.

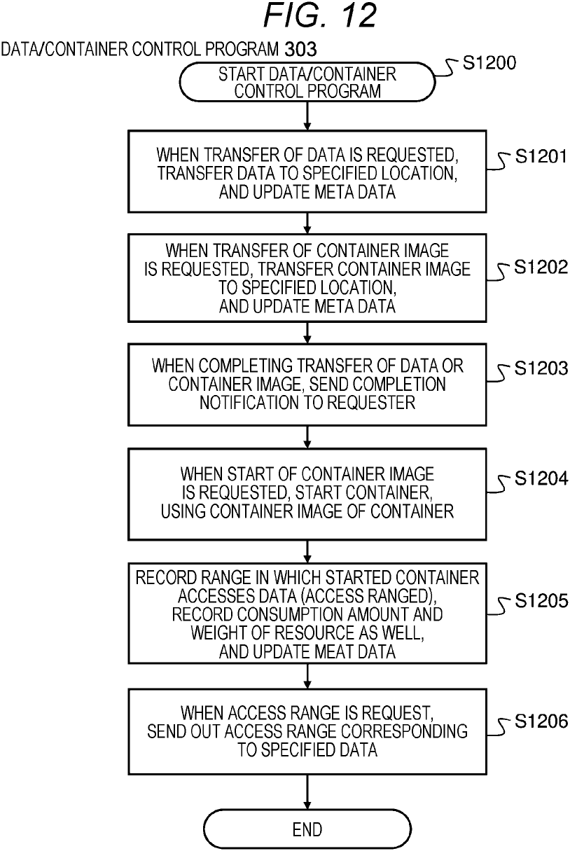

FIG. 12 is a flowchart showing an operation of the data/container control program 303 included in the system according to the embodiment of the present invention. The program 303 starts when called by a different program (S1200). The program then carries out a process in response to a request from the different program. First, when receiving a request for transferring data, the program 303 transfers the data to a specified place. A transfer origin and a transfer destination for the data can be specified in the form of the placement plan table 313. A process of actually transferring the data can be implemented by a secure copy (SCP) function and a file transfer protocol (FTP) function, etc., included in the basic software 305. Data transfer may be carried out in the form of data copying, in which case the data remains in both the transfer origin and the transfer destination. In any case, the results of data transfer are reflected also in metadata managed by the metadata server or the catalog server (S1201). When transfer of a container image is requested, the container image can be transferred in the same manner as the data is transferred at step S1201 (S1202). When finishing with transfer of the data and the container image, the program 303 notifies a program having made a data transfer request of completion of the data transfer (S1203). Where receiving a request for staring the container, the program 303 starts the container, using the specified container image. The container image can be specified, using the form of a transfer origin base in the row 711 and a transfer destination in the row 712 in the placement plan table 313 (S1204). When accessing data from an application running on the container started, the program 303 records an access range for accessing the data. There are various definitions of the access range and various methods of obtaining the access range. For example, the ratio of areas where access occurs can be obtained easily. Specifically, data is virtually divided into some blocks, and an access-made flag is set in blocks in which access has actually occurred. By continuing this process, blocks in which access has not occurred at all and blocks in which access has occurred can be confirmed. Hence the result of calculation of the ratio of blocks with access-made flags to the whole blocks is given as the access rang. The calculated latest access range can be stored in metadata managed by the metadata server or the catalog server. Similarly, the amount of consumption and the weight 604 of other resources being used for executing an application are measured and the latest measurements can be stored in the metadata managed by the metadata server or the catalog server (S1205). Thus, when receiving an access range request, the program 303 searches the metadata server or the catalog server to retrieve access range information corresponding to specified data and sends out the access range information in replay to the request (S1206).

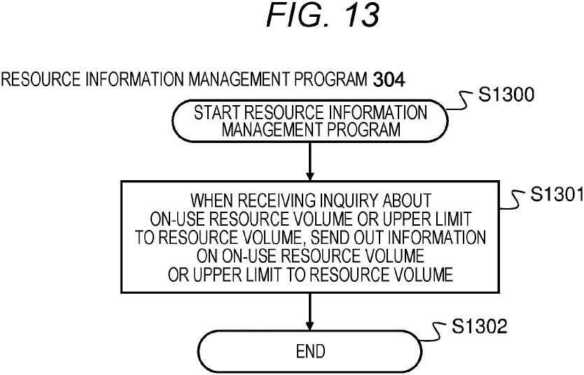

FIG. 13 is a flowchart showing an operation of the resource information management program 304 included in the system according to the embodiment of the present invention. The program 304 starts when called by the on-proposal resource management program 301 (S1300). The program 304 acquires the maximum volumes and on-use volumes of resources, using the functions of the basic software 305, especially its OS function. The program 304 then collects the maximum volumes and on-use volumes in requested node units, such as base-by-base and server-by-server units, and sends them back in the form of a single or, if necessary, multiple resource information tables 310 and 311 (S1301). When sending back the maximum volumes and on-use volumes is completed, the above program is ended, and the next request (updating to the latest information) is waited (S1302).

### Modes of Present Invention

A mode 1 to a mode 5 of the present invention will hereinafter be described.

### <Mode 1>

To guarantee that a placement plan presented to the user is executable, necessary resources need to be reserved before the placement plan is presented to the user. Methods of making this guarantee are roughly classified into absolute guarantee and relative guarantee. The absolute guarantee guarantees the a requested resource volume in full. When the absolute guarantee fails to guarantee the requested resource volume in full, however, a resource reservation itself ends up in a failure. Besides, to guarantee that the user having reserved a resource without specifying its type is able to certainly use the resource at any given timing, a different user is not allowed to use the resource not used yet as far as the resource is reserved. The relative guarantee, which is defined in various ways, on the other hand, has a common definition that it guarantees the resource volume in full if possible and yet in the case of guaranteeing the resource volume in full is impossible, allows making a resource reservation in a range in which use of a remaining resource volume is guaranteed.

The present invention has features essential to implementation of the absolute guarantee and relative guarantee of resources distributed and placed in a wide area. However, when its features are narrowed down to the relative guarantee of resources necessary for execution of a placement plan, the present invention still offers features of allowing effective use of the resource if not in a wide area. Specifically, the present invention offers the following three features: a method of making the relative guarantee, a method of generating a placement plan, and timing of making the relative guarantee. Specific examples will hereinafter be described.

One of the concepts classified as the relative guarantee is a resource request method called burstable. According to the burstable, resources are requested by specifying two values: a guaranteed volume equivalent to a minimum necessary resource request volume that is absolutely guaranteed and an upper limit volume equivalent to a desirable maximum resource request volume.

A reservation is made by using these values. Within a reservation acceptance margin, a reservation is made by specifying the guaranteed volume, but physical resources are reserved without specifying the guaranteed volume so that a case where a physical resource cannot be used because of a reservation is avoided. For the reservation acceptance margin, the upper limit volume is specified as the value equal to the desirable maximum resource request volume, but for physical resources, a larger upper limit volume is specified so that the entire remaining physical resource can be used up. In other words, for the reservation acceptance margin and the remaining physical resource volume, the guarantee volume and upper limit volume are varied to make the relative guarantee.

In the past, such a concept of relative reservation was used for a reservation for physical resources, but was not applied to the reservation acceptance margin independently of the remaining physical resource volume. When the concept of relative reservation is applied to the reservation acceptance margin, repeatedly making reservations results in the following reservation patterns that grow tense step by step: (1) a reservation volume that can be guaranteed in full, (2) a reservation volume that cannot be guaranteed in full but can be reserved, (3) a reservation volume that reaches a threshold set as an upper limit by making only the minimum necessary resource request, and (4) a reservation volume that cannot afford a minimum allocation due to a resource shortage. When reservations are made repeatedly, the reservation acceptance margin decreases by at least the minimum necessary resource request volume (guarantee volume) at every reservation. As a result, making a reservation becomes impossible before resources become too short to meet reservations, which prevents a case where reservations are made in an excessive volume that exceeds the maximum volume of resources available.

For example, a simple determination method is used to determine whether a total guarantee volume exceeds a threshold given by “a constant as a margin + number of users currently making reservations × average of minimum necessary reservation volumes”. When the total guarantee volume exceeds the threshold, reservation acceptance is stopped. Preventing consumption of the reservation acceptance margin in full and keeping consumption of the reservation acceptance margin at a minimum necessary level offers an effect of preventing a case where the reservation acceptance margin is consumed in full in the proposal phase in which a QoS guarantee level required by the user and approval of a placement plan are not ensured yet and a reservation cancelling risk, etc., exists.

Meanwhile, physical resources can be used effectively by two effects. Firstly, by setting the guarantee volume of physical resources to zero, even a reserved resource can be used for other purposes effectively before being actually used by a user who has won the right to use the resource through competition. Secondly, in a case of reserving physical resources, such as a network band and an I/O band that are limited in volume and are shared among different users, the physical resources are reserved with an upper limit volume set higher than an upper limit volume requested by the user. This allows the entire resources available to be used up. For example, when a surplus in physical resource remains after multiple reservations are made, the surplus can be allocated as additional portions to individual reservations by various methods, such as proportional allocation or first-come, first-served priority. As a result, for example, data transfer between bases can be made in advance, which increases resources that can be used to process new requests expected to be made in future.

Specifically, if the amount of data having been transferred in the above manner exceeds a value given by multiplying together the original network bandwidth and an elapsed time 662, the difference between the amount of data and the value is equivalent to a portion of data having been transferred in advance. The network bandwidth is thus reduced by a size equivalent to the portion of data having been transferred in advance to provide a portion of the network bandwidth resource available, which can be used by another data transfer process. The amount of data having been transferred in advance can be known by referring to a size in the row 715 in the placement plan table 313 and to a storage capacity in the row 614 that is a resource for storing the data. The size of data having been transferred is recorded in these items of size and storage capacity. The above methods thus offer an effect that more placement plans can be presented to more users.

Features of the method of generating a placement plan will then be described. A placement plan can be derived by a simple resource allocation program including a combination of loops and conditional branches, and may also be generated by using an existing mathematical algorithm, such as linear programming or minimum cost flow problem. Furthermore, a solution using a quantum computer called quantum annealing or a method of reproducing a quantum computer in a pseudo manner, using such a semiconductor element as CMOS annealing, may also be used. It is assumed, according to the present invention, that an applicable method is adopted from these methods on a necessary basis. These methods can be roughly classified into a category of simple resource allocation and other two types of categories including a quantum computer, and a difference between the methods arises when a plurality of containers are placed. According to the method based on simple resource allocation, reservation and placement are determined simultaneously and are carried out in order for each container. According to the methods using a quantum computer or a simulated version thereof, on the other hand, overall placement is determined first and then resources necessary for the placement are reserved all at once. In this case, the absolute guarantee, a system in which a reservation fails when full-volume guarantee cannot be made, involves a risk that reserving a derived placement plan fails to immediately make the placement plan useless. In the case of relative guarantee, on the other hand, a reservation can be made within the range of remaining resources and therefore a proposal, which at least meets the user’s minimum request, if not make full-volume guarantee, can be presented to the user. In addition, when a calculated placement plan is saved and reused, resources necessary for placement are reserved all at once. This avoids a failure in reservation.

Finally, timing of making the relative guarantee will be described. As described above, a point of time at which the relative guarantee can be made is a point of time at which deriving a placement plan is in progress or a point of time right after deriving a placement plan is over. A reservation needs to be completed before presentation of the placement plan to the user. It can be considered, however, that no reservation failure occurs in the relative guarantee. Strictly speaking, therefore, the reservation needs to be completed before a point right before the user’s selection or approval of the placement plan is permitted. In other words, a placement plan presentation process including drawing of the placement plan and a resource reservation process can be executed in parallel. Upon completion of the reservation, the user’s selection or approval of the placement plan is then permitted. Such timing of execution of the relative guarantee that offers an effect of preventing resource loss due to the occurrence of rework has not been defined so far. In concurrent with permission to the user’s selection or approval of the placement plan, a reservation result, such as whether a full-amount reservation has been made, and a remaining resource volume are reported to the user. As a result, a QoS guarantee level, which can be selected by the QoS request input interface 540, and a warning message are changed. For example, when the full-amount reservation has not been made, a warning message is displayed to warn the user of a possibility that wait for a free resource may arise at selection of the absolute guarantee or selection of the absolute guarantee is made impossible. When a resource shortage occurs when a QoS request is changed from the relative guarantee to the absolute guarantee on the QoS request input interface 540, an error message “resource shortage” is displayed to cancel the change to the absolute guarantee. Further, changes in the remaining resource volume are reported regularly and when the remaining resource volume drops below a given threshold, a warning message, such as “little room for accepting the absolute guarantee”, is displayed, or values in the QoS request input interface 540, the maximum examination time input interface 550, and the desirable processing time input interface 560, the values being inputted by the user who is examining the placement plan, are periodically read to update values in value type 603 and time information in the row 662 of the resource information table 312 and in the rows 718 and 719 of the placement plan table 313.

The above feature offers an effect achieved by making the relative guarantee before presentation of the placement plan to the user, and allows effective use of the reservation acceptance margin and resources that are temporarily reserved and are actually not used at present.

### <Mode 2>

When resources distributed and placed in a wide area are to be reserved with the absolute guarantee or the relative guarantee, a remaining resource volume that can be reserved cannot be grasped in real time, which is a problem. The present invention has a function of grasping the volume of remaining resources distributed and placed in a wide area, the function being essential to implementation of the absolute guarantee and the relative guarantee of resources distributed in a wide area. When numbers of bases are distributed and placed in a wide range, in particular, it is necessary to collect information on the resource volumes of those numbers of bases regularly or irregularly by flexibly dealing with various communication delays. The interval between acquisition of the resource information tables 310 and 311 indicating the latest resource status of a certain base and next acquisition of the latest information is long, and when the latest information is obtained is not certain. When a remaining resource volume obtained in such a manner is confirmed and a reservation and approval of a new placement plan are made, executing the placement plan requires that completion of transfer of necessary data be waited. It is not until the next cycle of collecting information from the resource information tables 310 and 311, the cycle beginning after the start of the container, that consumption of a reserved resource is reflected in the resource information tables 310 and 311. In addition, a fact that the container ends its operation to release the resource is not reflected until the next cycle of collecting information from the resource information tables 310 and 311. To deal with this problem, according to the present invention, the resource information table 312 holding a reserved on-proposal resource volume still holds the on-proposal resource volume even after the user selects one placement plan and keeps holding it until the next cycle of collecting information from the resource information tables 310 and 311. At calculation of a remaining resource volume, the calculation “resource maximum volume-on-use resource volume-on-proposal resource volume” is made to obtain the remaining resource volume, using the latest resource information tables 310, 311, and 312. It should be noted, however, that depending on whether a resource state in the row 663 is the preparation state 671 or the started state 672, the on-proposal resource volume in the resource information table 312 varies. To know current remaining resource volume, the on-proposal resource volume in a resource state shown in the row 663 is referred to. To determine whether a reservation is possible, on the other hand, it is necessary to refer to a future remaining resource volume that results after the start of the container. In this case, every remaining resource volume is calculated by referring to the on-proposal resource volume in the resource information table 312 that is considered to be in the started state 672, regardless of a resource state in the row 663. This separate use of the current resource state and the future resource state is made possible by estimating a state in the row 663 at a time at which a placement plan to be reserved is executed. Specifically, by referring to an execution start time of the container and a desirable processing time that are stored in time information in the row 662 and adding them up, how long the container will keep operating can be determined. In addition, by referring to the size of allocated data in the row 715 and a network band in the row 612 and dividing the size by the bandwidth, how long data transfer will continue can be determined.

The above feature makes it possible to derive a placement plan in a wide area and make the relative guarantee or the absolute guarantee before presenting the placement plan to the user. Hence free resources distributed and placed in wide area can be used effectively.

### <Mode 3>

The procedure of eliminating redundant resource placement between different placement plans and making a temporary reservation, the procedure being carried out at step S805, may be carried out by a different procedure equivalent to the procedure carried out at step S805. For example, when a plurality of derived placement plans are presented to the user, resources required for individual placement plans are aggregated to a maximum resource volume for each base and then the relative reservation is made. When the user has selected a placement plan, the maximum resource volume is switched to a reserved resource volume necessary and a portion of resource that is no longer necessary is released. In this case, the redundant flag in the row 720 is useful. For a reservation that exceeds the maximum resource value for each base, the flag is set to make the reservation out of the category of the relative reservation. This excludes the reservation from the subject of final resource release.

The above feature makes it possible to reduce unnecessary, excessive temporary reservations. Hence the reservation acceptance margin, which is a resource directly related to a business opportunity, can be used effectively.

### <Mode 4>

In a case where a process with a very long processing time is placed or a process that is executed semi-permanently is placed, waiting a free resource, a process executed at step S1106, may possibly be an unrealistic approach. In such a use case, reserve acceptance setting is changed to setting that prevents the occurrence of a resource shortage at step S1105 so that wait for a free resource never occur. Specifically, when a very long time is set as a desirable processing time or a long time is set as a processing time held in time information in the row 662 of the resource information table 312 for an on-proposal resource volume already reserved and waiting for a free resource is considered to be not realistic, a QoS request in the QoS request input interface 540 for reserving with the relative guarantee and then switching to the absolute guarantee is not supported, and a request resource volume corresponding to a QoS request set in the QoS request input interface 540 is reserved immediately with the absolute guarantee. This is because that when only the process to be executed for a long time is present, there is little chance of a resource change that allows an option of securing a minimum necessary resource volume when resources get scarce while reserving a resource volume in full when free resources becomes plenty, and full-volume resource allocation cannot be obtained unless a full-volume resource reservation is made from the start. Whether waiting for a free resource is unrealistic can be determined by checking whether a waiting time exceeds a set threshold. In a case where a reservation fails, a warning message is displayed to notify the user of a possibility of a derived placement plan being not executed for a very long time or no chance of getting full-volume resource allocation. In addition, to prevent deriving of such a placement plan that will not be executed for a long period in the first place, the threshold for preventing excessive reservations described in first mode is adjusted in its calculation to give the threshold a sufficiently large margin. Alternatively, to allow setting to narrow the reservation acceptance range to a range in which the absolute guarantee is possible or enable more precise determination, minimum necessary resource request volumes currently specified by all users who are making reservations are acquired in real time and a determination on whether sufficient resources required for executing a proposed placement plan are available, which is the determination at S803, is made. When the resources are insufficient, the user is informed of the proposed placement plan being not executable, and a QoS request in the QoS request input interface 540 is properly limited.

In placement of a process with a very long processing time, the above feature prevents deriving of an invalid placement plan that is practically unlikely to be actually placed and the occurrence of wait for placement that takes an unrealistic waiting time. Hence resources can be used effectively.

### <Mode 5>

In the present invention, resources that become bottlenecks vary, depending on a system configuration. Which resource is a bottleneck can be easily determined by actually accepting reservations and confirming a resource with the least surplus resource. In a case where the band of the wide area network 110 is narrow and becomes a bottleneck, the system setting is changed to setting that improves the resource use efficiency of the wide area network. Specifically, even when necessary and sufficient resources are secured by the absolute guarantee, an additional extra resource (desirable maximum resource request volume) that needs no guarantee is also requested so that the band can be used up to its upper limit when having a surplus band. In other words, a resource request is switched to a relative guarantee type request, such as a barstable-type request. In the same manner, even when the relative guarantee setting is made originally, the original setting is switched so that the desirable maximum resource request volume is expanded and an additional extra resource is requested to use the band up to its upper limit. It should be noted, however, that the additional extra resource request made by this setting change is given the lowest priority in resource allocation. As a result, even in the case of the absolute guarantee, data transfer is made ahead of a schedule. If the user want to stick to a scheduled data transfer time, the user just has to wait for the container to start, which causes no particular trouble. A portion of the network band that is set free because of data transfer ahead of the schedule is used for other data transfer ahead of the schedule or additional data transfer resulting from acceptance of a new reservation. This allows efficient use of resources.

In the next case where the CPU or the memory is a bottleneck, by changing the system setting, a placement plan deriving algorithm is used, the algorithm being capable of proposing a placement plan using a meter-rate charge system resource on a public cloud that allows additional on-demand contracting, or resource waiting is carried out at each base or control server and a next request can be placed as soon as a free resource become available. These effects allow effective use of resources. For example, when open source software for managing a container, such as Kubernetes included in the basic software 305, is used at each base, a request for container placement is made to wait in a scheduler when resources are insufficient, and the container is set in place as soon as resources are available. Alternatively, for example, where a dedicated scheduler in the control server waits for a free resource, a request from a user having set a shorter maximum examination time is processed in priority for resource placement. This ensures fairness.

Specifically, because a user having set a longer maximum examination time have been in a state of being allowed to make a temporary resource reservation for a long time. This means that the user has made a part of the reservation acceptance margin unusable for a long time, the reservation acceptance margin being necessary for proposing placement plans to other users. It is therefore fair that the user is given lower priority in executing the container as compensation for causing such inconvenience. More precisely, it is preferable that a request from a user with the result of “time when examination of placement plan is started + maximum examination time-current time” being smaller be processed in priority. Such control can also be carried out by modifying an existing Kubanetis scheduler. A time when examination of a placement plan is started (a time when a resource is temporarily reserved) and a maximum examination time are held in time information in the row 662. The current time can be known by using the clock function of the basic software 305.

The above feature allows effective use of resources constituting bottlenecks.

The present invention is not limited to the above embodiment and modes, and various modifications may be adopted within the scope of the present invention. The above embodiment and modes may be combined with each other, providing that such combinations do not depart from the scope of the present invention.

The present invention may also be configured as follows.

[1] A computer system including a plurality of computers connected through a network, and a specific computer, in which
the specific computer generates and proposes a placement plan that determines a place of execution of a process a user wants to execute in the computer system, the process being inputted to the specific computer, and placement of data necessary for the process,
the specific computer determines whether a resource necessary for executing the process is present in the computer system,
the specific computer determines that generating the placement plan is possible when relative guarantee is possible in the computer system, the relative guarantee guaranteeing a guarantee volume that is at least an absolute resource volume and, if possible, guaranteeing a resource volume reaching an upper limit volume larger than the guarantee volume, for a reservation acceptance limit equivalent to a resource volume serving as criteria for determining whether a reservation for a resource necessary for executing the process is acceptable, and starts generating the placement plan that determines a place of execution of the process and placement of data necessary for the process, and
in a period between right after start of generation of the placement plan and right before permission to selection and approval of the proposed placement plan, the specific computer makes a reservation with the relative guarantee that for the resource and the reservation acceptance limit, makes the guarantee volume and the upper limit volume for a resource volume of the resource different respectively from the guarantee volume and the upper limit volume for the reservation acceptance limit.

[2] A computer system including a plurality of computers distributed and placed in a wide area and connected through a network, and a specific computer, in which
the specific computer generates and proposes a placement plan that determines a place of execution of a process a user wants to execute in the computer system, the process being inputted to the specific computer, and placement of data necessary for the process,
the specific computer collects and updates resource information at given timing, the resource information being information on a resource volume of the computers placed in remote places,
to determine whether a resource necessary for execution of the process the user wants to execute is present, the specific computer calculates an available resource volume, based on collected resource information, on-propose resource information, and a remaining processing time,
based on the available resource volume, the specific computer generates one or a plurality of the placement plans that determine a place of execution of the process and placement of data necessary for the process, and proposes one or the plurality of the placement plans generated,
when one or the plurality of placement plans are selected and approved by the user and a placement plan not selected by the user is present, the specific computer releases the on-proposal resource information on the placement plan not selected by the user, from a subject of calculation of the available resource volume, and
after data transfer according to the selected and approved placement plan necessary for execution of the process and container transfer for executing the process are carried out, the specific computer releases the on-proposal resource information on the selected and approved placement plan from a subject of calculation of the available resource volume at timing of next updating of the resource information.

[3] The computer system according to [1], in which
for the resource, the specific computer makes a reservation with the relative guarantee that makes the guarantee volume zero or does not specify the guarantee volume, and
for the reservation acceptance limit, the specific computer makes a reservation with the relative guarantee that specifies a resource volume the placement plan generated at least requires, as the guarantee volume.

[4] The computer system according to [1], in which

for the resource, the specific computer makes a reservation with the relative guarantee that specifies a volume allowing a resource volume of the resource to be entirely used up, as the upper limit volume.

[5] The computer system according to [1] or [2], in which
when a plurality of the placement plans are generated and the same resources related to the placement plan are redundantly placed among the placement plans, the specific computer sets a redundancy flag indicating that the same resources related to the placement plan that are redundantly placed among the placement plans, except one of the same resources, are excluded from a subject of a reservation,
the specific computer reserves a resource related to the placement plan, the resource having no redundancy flag set therefor, and
when, by a user’s input, one of the placement plans is selected, a resource related to the placement plan, the resource being not selected by the user and having no redundancy flag set for the resource, is released from a subject of the reservation.

[6] The computer system according to [1] or [2], in which
the specific computer checks whether a use time of the resource is long, the resource being reserved according to the placement plan, and
when confirming that the use time of the resource is long, the resource being reserved according to the placement plan, the specific computer determines that when a QoS guarantee level is switched from relative guarantee to absolute guarantee by the user’s switching operation, wait for a long time is expected to arise because a reservation that makes the use time of the resource long has been made, the resource having the QoS guarantee level that is to be switched to the absolute guarantee by the user’s switching operation, and carries out a warning process for warning the user of the wait for a long time.

[7] The computer system according to [1] or [2], in which
the specific computer checks whether a use time of the resource is long, the resource being reserved according to the placement plan, and
when confirming that the use time of the resource is long, the resource being reserved according to the placement plan, the specific computer determines that when a QoS guarantee level is switched from relative guarantee to absolute guarantee by the user’s switching operation, wait for a long time is expected to arise because a reservation that makes the use time of the resource long has been made, the resource having the QoS guarantee level that is to be switched to the absolute guarantee by the user’s switching operation, and prohibits a switching operation for switching the QoS guarantee level.

[8] The computer system according to [1] or [2], in which

when a maximum examination time is inputted or selected by the user, the specific computer determines a resource that is a bottleneck, changes setting of a system to setting that allows efficient use of the resource that is the bottleneck, according to the bottleneck, and when necessity of waiting execution of a container for executing the process until the resource becomes available as a free resource arises because of change of the setting, executes in priority the container with a shorter maximum examination time set therefor.

[9] The computer system according to [1] or [2], in which

the specific computer is capable of selecting either relative guarantee or absolute guarantee, according to a user’s request and a resource type.

[10] The computer system according to [1] or [2], in which

when reserving a storage capacity as a resource, the specific computer reserves a data size of an access range as a minimum necessary resource volume in a reservation with relative guarantee.

[11] The computer system according to [1] or [2], in which

when reserving the resource, the specific computer is able to reserve the resource by reserving a budget necessary for securing the resource.

[12] A placement plan proposal method executed in a computer system including a plurality of computers connected through a network and a specific computer, to cause the specific computer to generate and propose a placement plan that determines a place of execution of a process a user wants to execute in the computer system, the process being inputted to the specific computer, and placement of data necessary for the process, in which
the placement plan proposal method causes the specific compute to:
   determine whether a resource necessary for executing the process is present in the computer system;
   determine that generating the placement plan is possible when relative guarantee is possible in the computer system, the relative guarantee guaranteeing a guarantee volume that is at least an absolute resource volume and, if possible, guaranteeing a resource volume reaching an upper limit volume larger than the guarantee volume, for a reservation acceptance limit equivalent to a resource volume serving as criteria for determining whether a reservation for a resource necessary for executing the process is acceptable, and start generating the placement plan that determines a place of execution of the process and placement of data necessary for the process; and
   in a period between right after start of generation of the placement plan and right before permission to selection and approval of the proposed placement plan, make a reservation with the relative guarantee that for the resource and the reservation acceptance limit, makes the guarantee volume and the upper limit volume for a volume of the resource different respectively from the guarantee volume and the upper limit volume for the reservation acceptance margin.

What is claimed is:

1. A computer system comprising a plurality of computers connected through a network, and a specific computer, wherein
the specific computer generates and proposes a placement plan that determines a place of execution of a process a user wants to execute in the computer system, the process being inputted to the specific computer, and placement of data necessary for the process,
the specific computer determines whether a resource necessary for executing the process is present in the computer system,
the specific computer determines that generating the placement plan is possible when relative guarantee is possible in the computer system, the relative guarantee guaranteeing a guarantee volume that is at least an absolute resource volume and, if possible, guaranteeing a resource volume reaching an upper limit volume larger than the guarantee volume, for a reservation acceptance limit equivalent to a resource volume serving as criteria for determining whether a reservation for a resource necessary for executing the process is acceptable, and starts generating the placement plan that determines a place of execution of the process and placement of data necessary for the process, and
in a period between right after start of generation of the placement plan and right before permission to selection and approval of the proposed placement plan, the specific computer makes a reservation with the relative guarantee that for the resource and the reservation acceptance limit, makes the guarantee volume and the upper limit volume for a resource volume of the resource different respectively from the guarantee volume and the upper limit volume for the reservation acceptance limit.

2. A computer system comprising a plurality of computers distributed and placed in a wide area and connected through a network, and a specific computer, wherein
the specific computer generates and proposes a placement plan that determines a place of execution of a process a user wants to execute in the computer system, the process being inputted to the specific computer, and placement of data necessary for the process,
the specific computer collects and updates resource information at given timing, the resource information being information on a resource volume of the computers placed in remote places,
to determine whether a resource necessary for execution of the process the user wants to execute is present, the specific computer calculates an available resource volume, based on collected resource information, on-propose resource information, and a remaining processing time,
based on the available resource volume, the specific computer generates one or a plurality of the placement plans that determine a place of execution of the process and placement of data necessary for the process, and proposes one or the plurality of the placement plans generated,
when one or the plurality of placement plans are selected and approved by the user and a placement plan not selected by the user is present, the specific computer releases the on-proposal resource information on the placement plan not selected by the user, from a subject of calculation of the available resource volume, and
after data transfer according to the selected and approved placement plan necessary for execution of the process and container transfer for executing the process are carried out, the specific computer releases the on-proposal resource information on the selected and approved placement plan from a subject of calculation of the available resource volume at timing of next updating of the resource information.

3. The computer system according to claim 1, wherein
for the resource, the specific computer makes a reservation with the relative guarantee that makes the guarantee volume zero or does not specify the guarantee volume, and
for the reservation acceptance limit, the specific computer makes a reservation with the relative guarantee that specifies a resource volume the placement plan generated at least requires, as the guarantee volume.

4. The computer system according to claim 1, wherein
for the resource, the specific computer makes a reservation with the relative guarantee that specifies a volume allowing a resource volume of the resource to be entirely used up, as the upper limit volume.

5. The computer system according to claim 1, wherein
when a plurality of the placement plans are generated and same resources related to the placement plan are redundantly placed among the placement plans, the specific computer sets a redundancy flag indicating that the same resources related to the placement plan that are redundantly placed among the placement plans, except one of the same resources, are excluded from a subject of a reservation,
the specific computer reserves a resource related to the placement plan, the resource having no redundancy flag set therefor, and
when, by a user’s input, one of the placement plans is selected, a resource related to the placement plan, the resource being not selected by the user and having no redundancy flag set for the resource, is released from a subject of the reservation.

6. The computer system according to claim 1, wherein
the specific computer checks whether a use time of the resource is long, the resource being reserved according to the placement plan, and
when confirming that the use time of the resource is long, the resource being reserved according to the placement plan, the specific computer determines that when a QoS guarantee level is switched from relative guarantee to absolute guarantee by the user’s switching operation, wait for a long time is expected to arise because a reservation that makes the use time of the resource long has been made, the resource having the QoS guarantee level that is to be switched to the absolute guarantee by the user’s switching operation, and carries out a warning process for warning the user of the wait for a long time.

7. The computer system according to claim 1, wherein
the specific computer checks whether a use time of the resource is long, the resource being reserved according to the placement plan, and
when confirming that the use time of the resource is long, the resource being reserved according to the placement plan, the specific computer determines that when a QoS guarantee level is switched from relative guarantee to absolute guarantee by the user’s switching operation, wait for a long time is expected to arise because a reservation that makes the use time of the resource long has been made, the resource having the QoS guarantee level that is to be switched to the absolute guarantee by the user’s switching operation, and prohibits a switching operation for switching the QoS guarantee level.

8. The computer system according to claim 1, wherein
when a maximum examination time is inputted or selected by the user, the specific computer determines a resource that is a bottleneck, changes setting of a system to setting that allows efficient use of the resource that is the bottleneck, according to the bottleneck, and when necessity of waiting execution of a container for executing the process until the resource becomes available as a free resource arises because of change of the setting, executes in priority the container with a shorter maximum examination time set therefor.

9. The computer system according to claim 1, wherein
the specific computer is capable of selecting either relative guarantee or absolute guarantee, according to a user’s request and a resource type.

10. The computer system according to claim 1, wherein
when reserving a storage capacity as a resource, the specific computer reserves a data size of an access range as a minimum necessary resource volume in a reservation with relative guarantee.

11. The computer system according to claim 1, wherein
when reserving the resource, the specific computer is able to reserve the resource by reserving a budget necessary for securing the resource.

12. A placement plan proposal method executed in a computer system comprising a plurality of computers connected through a network and a specific computer, to cause the specific computer to generate and propose a placement plan that determines a place of execution of a process a user wants to execute in the computer system, the process being inputted to the specific computer, and placement of data necessary for the process, wherein
the placement plan proposal method causes the specific compute to:
determine whether a resource necessary for executing the process is present in the computer system;
determine that generating the placement plan is possible when relative guarantee is possible in the computer system, the relative guarantee guaranteeing a guarantee volume that is at least an absolute resource volume and, if possible, guaranteeing a resource volume reaching an upper limit volume larger than the guarantee volume, for a reservation acceptance limit equivalent to a resource volume serving as criteria for determining whether a reservation for a resource necessary for executing the process is acceptable, and start generating the placement plan that determines a place of execution of the process and placement of data necessary for the process; and
in a period between right after start of generation of the placement plan and right before permission to selection and approval of the proposed placement plan, make a reservation with the relative guarantee that for the resource and the reservation acceptance limit, makes the guarantee volume and the upper limit volume for a volume of the resource different respectively from the guarantee volume and the upper limit volume for the reservation acceptance limit.
